(19) United States
(12) Patent Application Publication
(10) Pub. No.: US 2023/0127699 A1
(43) Pub. Date: Apr. 27, 2023

(54) METHOD OF TRAINING MODEL AND METHOD OF DETERMINING ASSET VALUATION

(71) Applicant: BEIJING BAIDU NETCOM SCIENCE TECHNOLOGY CO., LTD., Beijing (CN)

(72) Inventors: Ji Liu, Beijing (CN); Sunjie Yu, Beijing (CN); Weijia Zhang, Beijing (CN); Hao Liu, Beijing (CN); Hengshu Zhu, Beijing (CN); Dejing Dou, Beijing (CN); Hui Xiong, Beijing (CN)

(73) Assignee: BEIJING BAIDU NETCOM SCIENCE TECHNOLOGY CO., LTD., Beijing (CN)

(21) Appl. No.: 18/088,872

(22) Filed: Dec. 27, 2022

(30) Foreign Application Priority Data
Dec. 29, 2021 (CN) 202111646847.3

(51) Int. Cl. G06N 20/00; G06Q 50/16

(52) U.S. Cl. CPC G06N 20/00; G06Q 50/16

(57) ABSTRACT

A method of training a model, a method of determining an asset valuation, a device, a storage medium, and a program product, which relate to a field of artificial intelligence, in particular to fields of deep learning and natural language understanding. A specific implementation can include: determining an event-level representation according to a first set of feature data; performing a multi-task learning for a first model according to the event-level representation, to obtain first price distribution data, and transmitting the first price distribution data to a central server; determining a first intra-region representation according to a second set of feature data; adding a noise signal to the first intra-region representation, and transmitting the noised intra-region representation to a client; and adjusting a parameter of the first model according to a noised parameter gradient in response to the noised parameter gradient being received from the central server.

This application claims priority to Chinese Patent Application No. 202111646847.3 filed on Dec. 29, 2021, which is incorporated herein in its entirety by reference.

### TECHNICAL FIELD

The present disclosure relates to a field of an artificial intelligence technology, in particular to fields of deep learning and natural language understanding technologies.

### BACKGROUND

A real estate appraisal refers to a process of forming an unbiased opinion about a market value of real estate, which plays a vital role in decision-making of various participants in a market (such as real estate agents, appraisers, lenders and buyers).

### SUMMARY

The present disclosure provides a method of training a model, a method of determining an asset valuation, a device, and a storage medium.

According to an aspect of the present disclosure, a method of training a model is provided, including: determining an event-level representation according to a first set of feature data; performing a multi-task learning for a first model according to the event-level representation, so as to obtain first price distribution data, and transmitting the first price distribution data to a central server; determining a first intra-region representation according to a second set of feature data; adding a noise signal to the first intra-region representation to obtain a noised intra-region representation, and transmitting the noised intra-region representation to a client; and adjusting a parameter of the first model according to a noised parameter gradient in response to the noised parameter gradient being received from the central server.

According to another aspect of the present disclosure, a method of training a model is provided, including: receiving a noised intra-region representation from a client; determining a region-level representation according to a third set of feature data and the noised intra-region representation; performing a multi-task learning for a second model according to the noised intra-region representation and the region-level representation, so as to obtain second price distribution data; transmitting the second price distribution data to a central server; and adjusting a parameter of the second model according to a noised parameter gradient in response to the noised parameter gradient being received from the central server.

According to another aspect of the present disclosure, a method of training a model is provided, including: receiving first price distribution data from a first client and second price distribution data from a second client; determining a parameter gradient according to the first price distribution data and the second price distribution data; adding a noise to the parameter gradient to obtain a noised parameter gradient; and transmitting the noised parameter gradient to the first client and the second client.

According to another aspect of the present disclosure, a method of determining an asset valuation is provided, including: inputting a first set of feature data into a first model to obtain an event-level representation; inputting a second set of feature data into a second model to obtain a region-level representation; and determining the asset valuation according to the event-level representation and the region-level representation.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the methods described in embodiments of the present disclosure.

According to another aspect of the present disclosure, a non-transitory computer-readable storage medium having computer instructions therein is provided, and the computer instructions are configured to cause a computer to implement the methods described in embodiments of the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1A shows a schematic diagram of an architecture of a fed-MugRep framework according to embodiments of the present disclosure;

FIG. 1B schematically shows a schematic diagram of performing a model training based on a fed-Mug Rep framework according to embodiments of the present disclosure;

FIG. 2 schematically shows a flowchart of a method of training a model according to embodiments of the present disclosure;

FIG. 3 schematically shows a flowchart of a method of determining an event-level representation according to embodiments of the present disclosure;

FIG. 4 schematically shows a flowchart of a method of performing a multi-task learning for a first model according to embodiments of the present disclosure;

FIG. 5 schematically shows a flowchart of a method of determining a first intra-region representation in according to embodiments of the present disclosure;

FIG. 6 schematically shows a flowchart of a method of calculating a noise value of a noise signal according to embodiments of the present disclosure;

FIG. 7 schematically shows a flowchart of a method of determining a region-level representation according to embodiments of the present disclosure;

FIG. 8 schematically shows a flowchart of a method of performing a multi-task learning for a second model according to embodiments of the present disclosure;

FIG. 9 schematically shows a flowchart of a method of determining an asset valuation according to embodiments of the present disclosure;

FIG. 10 schematically shows a block diagram of an apparatus of training a model according to embodiments of the present disclosure;

FIG. 11 schematically shows a block diagram of an apparatus of training a model according to other embodiments of the present disclosure;

FIG. 12 schematically shows a block diagram of an apparatus of training a model according to embodiments of the present disclosure; and

FIG. 13 schematically shows a block diagram of an example electronic device for implementing embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

It should be understood that a multi-task learning refers to simultaneous parallel learning of a plurality of related tasks, simultaneous back-propagation of gradients, and mutual learning of a plurality of tasks through an underlying shared representation to improve a generalization effect. In simple terms, the multi-task learning may put a plurality of related tasks together for learning. During a learning process, a plurality of tasks may share and supplement domain-related information learned from other related tasks through a shallow shared representation, so as to promote learning mutually and improve the generalization effect.

As an optional solution, a multi-task hierarchical graph representation learning (Mug Rep) framework may be utilized for an asset valuation. An asset may include, for example, real estate. Based on the MugRep, it is possible to firstly acquire and integrate multi-source urban data, construct a set of feature data, and analyze the asset from a plurality of perspectives (such as geographical distribution, mobility distribution, and resident distribution, etc.). Then, it is possible to build an evolving asset transaction graph and corresponding event graph convolution module and a hierarchical heterogeneous region graph convolution module. Subsequently, asset valuations with different distributions may be generated by using a multi-task learning module that divides a task by an urban area.

The source data used to construct the feature set in the Mug Rep may come from a plurality of data sources, such as data source A and data source B. In the context of a task of asset valuation, the source data may involve a large amount of private data. For example, the source data provided by data source A may include a regional population mobility, an income level of permanent residents, etc., and the source data provided by data source B may include a transaction amount of a single asset, etc.

If the data is explicitly visible between the two data sources during an implementation of the Mug Rep, that is, the two data sources may access each other's source data, it may lead to a leakage of user data in an actual application process, which has a potential security risk.

Based on this, according to embodiments of the present disclosure, a vertical federated learning may be introduced on the basis of the original MugRep framework to form a new framework, hereinafter referred to as a fed-Mug Rep framework. The fed-Mug Rep framework may protect a security of source data by isolating the source data and using a differential privacy during a data exchange, so that a privacy protection may be provided for multi-source data while performing an efficient modeling using the multi-source data.

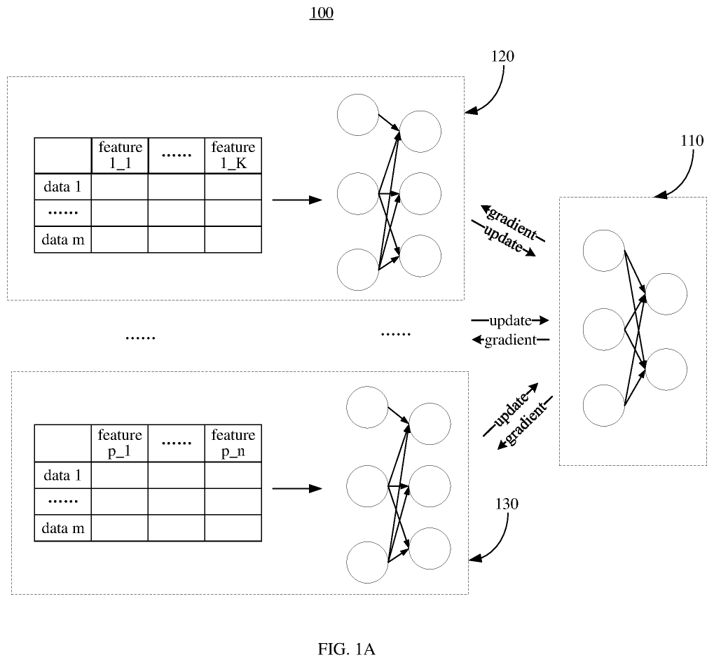

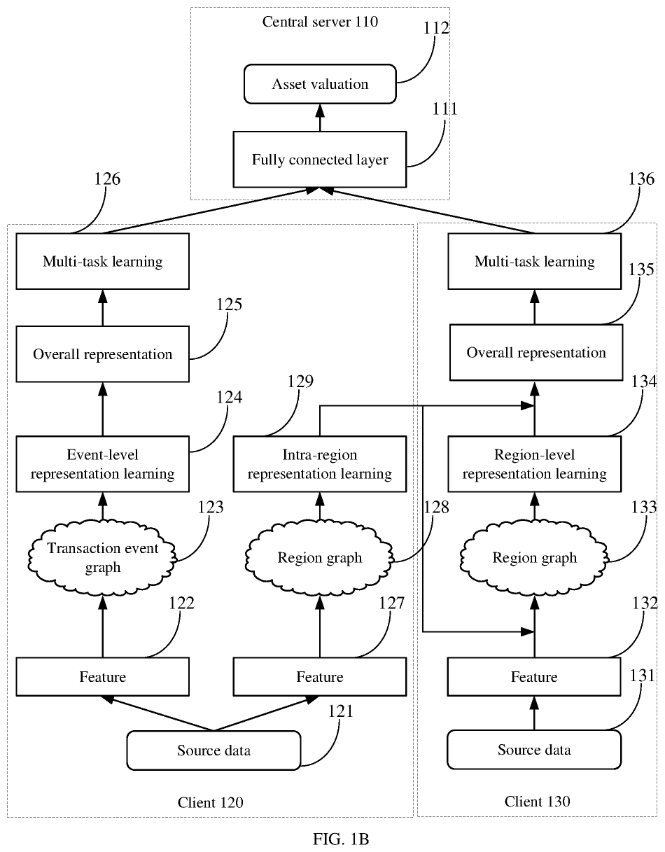

An architecture of the fed-Mug Rep framework according to embodiments of the present disclosure will be described below with reference to FIG. 1A.

FIG. 1A shows a schematic diagram of a fed-Mug Rep framework according to embodiments of the present disclosure.

As shown in FIG. 1A, a fed-MugRep framework 100 includes a client 110 and a plurality of clients, such as clients 120 and 130.

The client 110 and/or clients 120, 130 may be a cloud server, also known as a cloud computing server or a cloud host, which is a host product in a cloud computing service system to solve shortcomings of difficult management and weak service scalability existing in a conventional physical host and VPS (Virtual Private Server) service. The client 110 and/or clients 120, 130 may also be a server of a distributed system or a server combined with a block-chain.

In each iteration of model training, the client 110 may distribute a current federated model to a randomly selected client, such as clients 120 and 130. The clients 120 and 130 receiving the federated model may independently calculate gradients of the models according to their local data and transmit the gradients to the client 110. The client 110 may aggregate the received gradients to calculate a new federated model. Due to a need for privacy protection, the local data and training process of the clients 120 and 130 are invisible to the client 110.

According to embodiments of the present disclosure, the clients 120 and 130 are physically isolated from each other, and may save source data respectively. The source data may include a plurality of sets of feature data, such as data 1, . . . data m. Each set of feature data may include a plurality of features, such as feature 1_1, . . . feature 1_k, feature p_1, . . . feature p_n, etc. The clients 120 and 130 may perform a local training on a real estate valuation model in their own safe and trusted environments, and any source data from other parties is invisible during the training process, so that a possibility of source data exposure may be reduced.

Because the two data sources have a data exchange during an interconnection between a dynamic intra-region graph convolution module and a heterogeneous inter-region graph convolution module of the MugRep framework, there is a high risk of privacy leakage. The fed-Mug Rep framework according to embodiments of the present disclosure reflects a principle of minimizing a data collection, and may build a federated model for a set of local data while providing the privacy protection. In addition, the fed-Mug Rep framework may be applied to training of a large-scale distributed deep learning model.

FIG. 1B schematically shows a schematic diagram of performing a model training based on a fed-Mug Rep framework according to embodiments of the present disclosure.

As shown in FIG. 1B, according to embodiments of the present disclosure, source data 121 is stored in the client 120. The client 120 may include an event graph convolution module, a dynamic intra-region graph convolution module, and a multi-task learning module.

The event graph convolution module in the client 120 may be used to determine a feature 122 according to the source data 121. A transaction event graph 123 may then be determined according to the feature 122. Next, an event-level representation learning 124 is performed using the transaction event graph 123 to obtain an overall representation 125.

The multi-task learning module in the client 120 may be used to perform a multi-task learning according to the overall representation 125 to obtain first price distribution data. The first price distribution data is then transmitted to a central server 110.

The dynamic intra-region convolution module in the client 120 may be used to determine a feature 127 according to the source data 121. A region graph 128 may then be determined according to the feature 127. Next, an intra-region representation learning 129 is performed using the region graph 128 to obtain an intra-region representation, and the intra-region representation is transmitted to the client 130.

According to embodiments of the present disclosure, source data 131 may be stored in the client 130. The client 130 may include a hierarchical heterogeneous region graph convolution module. The hierarchical heterogeneous region graph convolution module may include a dynamic intra-region graph convolution module, a heterogeneous inter-region graph convolution module, and a multi-task learning module.

The dynamic intra-region graph convolution module in the client 130 may be used to determine a feature 132 according to the source data 131. A region graph 133 may then be determined according to the feature 132 and the intra-region representation from the client 120.

The heterogeneous inter-region graph convolution module in the client 130 may be used to perform an intra-region representation learning 134 by using the region graph 133 and the intra-region representation from the client 120, so as to obtain an overall representation 135.

The multi-task learning module in the client 130 may be used to perform a multi-task learning according to the overall representation 135 to obtain second price distribution data. The second price distribution data is then transmitted to the central server 110.

According to embodiments of the present disclosure, the central server 130 may include a fully connected layer 111. The first price distribution data from the client 120 and the second price distribution data from the client 130 may be input into the fully connected layer, so as to obtain an asset valuation. A gradient may be calculated according to the asset valuation and then transmitted to the client 120 and the client 130. The client 120 and the client 130 may adjust parameters of their respective models according to the gradient, so as to perform a model training.

According to embodiments of the present disclosure, if some model parameters of a participant are shared in the fed-Mug Rep framework, other participants may reversely deduce a source data distribution of the participant through the model parameters or gradients, which may also lead to a serious privacy leakage problem. Therefore, a noise may be introduced when the client 120 transmits the output of the dynamic intra-region graph convolution module to the heterogeneous inter-region graph convolution module in the client 130. In addition, a differential privacy may be added to the gradient when the central server 110 transmits the gradient to each participant. In this way, the risk of private data leakage may be reduced, and the security of private data may be improved.

The modules involved in the framework, including the event graph convolution module, the hierarchical heterogeneous region graph convolution module and the multi-task learning module, will be introduced in more detail below.

According to embodiments of the present disclosure, the event graph convolution module may be used to determine an event-level representation. An input to the event graph convolution module may include, for example, an asset profile feature and a temporal feature, and an output may include, for example, the event-level representation.

Due to a strong dependence of asset transaction prices generated in adjacent spaces or times, a transaction event graph may be constructed for asset transaction events (referred to as transaction events). A node in the transaction event graph represents a transaction event, and an edge between nodes represents a spatial or temporal correlation between the transaction events represented by the nodes. Each node may have a corresponding feature, and the feature may include, for example, an asset profile feature, a temporal feature, and so on. The asset may include, for example, real estate.

According to embodiments of the present disclosure, historical transaction events include t transaction events. Each transaction event has a feature and a transaction unit price, and the price may include, for example, the asset profile feature and the like. For a t′^{th} transaction event s_{t′}, a value range of t′ is 0<t′≤t, which means any one from 0 to t. An edge constraint is defined as follows.

$${e}_{( t + 1 ) {t}^{′}} = \{ \begin{matrix}1 , dis t ( {s}_{t + 1} , {s}_{{t}^{′}} ) \leq {ε}_{p} , 0 < ( {T}_{t + 1} - {T}_{{t}^{′}} ) \leq {ε}_{v} \\ 0 , otherwise\end{matrix}$$

where sₜ₊₁ represents a target transaction event, and a prediction target is the asset unit price of sₜ₊₁. dist(*) represents a physical distance between locations of two transaction events sₜ₊₁ and s_{t′}, Tₜ₊₁−T_{t′} represents an interval between occurrence times of the two transaction events, ϵₚ represents a physical distance limit, and ϵᵥ represents a time interval limit.

The above formula means that after the node t+1 is added, all nodes t′ within the range of 0<t′≤t are traversed, and an edge associating the node t+1 and the node t′ that meets a condition (such as the above-mentioned edge constraint) is added, so as to obtain the transaction event graph.

According to embodiments of the present disclosure, in order to quantify an impact of the historical transaction events on a current event, an attention mechanism is introduced as follows.

β_{(t+1)t′}=νₑ^{T} tanh(Wₑ[xₜ₊₁⊕x_{t′}⊕y_{t′}])

where νₑ and Wₑ are parameters that may be learned, xₜ₊₁ is a feature of the transaction event sₜ₊₁, x_{t′} is a feature of the transaction event s_{t′}, and y_{t′} is the transaction unit price of the transaction event s_{t′}. The feature may include, for example, the asset profile feature and the like.

A weight may then be calculated according to the following formula.

$${α}_{( t + 1 ) {t}^{′}} = \frac{exp ( {β}_{( t + 1 ) {t}^{′}} )}{{\sum }_{k ∈ {N}_{t + 1}} exp ( {β}_{( t + 1 ) k} )}$$

where Nₜ₊₁ is a set of transaction events adjacent to sₜ₊₁. Finally, an event-level representation of a I^{th} layer (representing a I^{th} graph convolution layer in an evolution graph) is obtained as follows.

h_{e,t+1}^{l}=ReLu(Wₕₑ^{l}(Σ_{t′∈N}_{ₜ₊₁}α_{(t+1)t′}h_{e,t′}^{l-1}+I(l>1)h_{e,t+1}^{l-1}))

where Wₕₑ^{l} is a parameter that may be learned, I(l>1) means 1 when I>1, and 0 for the rest, h_{e,t+1}⁰=xₜ₊₁.

According to embodiments of the present disclosure, the hierarchical heterogeneous region graph convolution module may be used to determine a region-level representation. An input to the hierarchical heterogeneous region graph convolution module may include, for example, a real estate profile feature, a community feature, a temporal feature, a geographical feature, a population visit feature, a mobility feature, and a resident population profile feature, etc., and an output may include, for example, the region-level representation. The hierarchical heterogeneous region graph convolution module may include a dynamic intra-region graph convolution module and a heterogeneous inter-region graph convolution module.

According to embodiments of the present disclosure, the dynamic intra-region graph convolution module may be used to provide an intra-region representation for the heterogeneous inter-region graph convolution module.

According to embodiments of the present disclosure, a region graph may be constructed for each region. A node in the region graph represents a transaction event in a corresponding region, and an edge between nodes represents a spatial or temporal correlation between the transaction events represented by the nodes. Each node may have a corresponding feature, and the feature may include, for example, an asset profile feature, a community feature, a temporal feature, a geographical feature, a population visit feature, a mobility feature, and a resident population profile feature. The region may include, for example, a community, and the transaction event may include, for example, a historical asset transaction event in the community.

According to embodiments of the present disclosure, for each region cⁱ, an edge constraint is defined for a transaction event in the region cⁱ as follows.

$${e}_{{t}^{′}}^{i} = \{ \begin{matrix}1 , 0 \leq ( {T}_{t} - {T}_{{t}^{′}} ) \leq max ( {ε}_{v} , {D}_{t , {N}_{c}}^{i} ) \\ 0 , otherwise\end{matrix}$$

where D_{t,N}_{_{c}}ⁱ represents a number of days between an N_{c}^{th} transaction event from latest and a last transaction event sₜⁱ in the region cⁱ.

An attention mechanism is introduced as follows.

β_{t′}ⁱ=νᵤ^{T} tanh(Wᵤ[x_{t′}ⁱ⊕y_{t′}ⁱ])

where νᵤ and Wᵤ are parameters that may be learned. In such embodiments, a weight α_{t′}ⁱ of the dynamic intra-region graph convolution module may be calculated according to the weight calculation formula used by the above-mentioned event graph convolution module. Then the intra-region representation may be calculated according to the following formula.))

hᵤⁱ=ReLu(Wₕᵤ(Σ_{t′∈N}_{ᵢ}α_{t′}ⁱx_{t′}ⁱ))

where hᵤⁱ represents the intra-region representation of the region cⁱ, and Wₕᵤ is a parameter that may be learned.

According to embodiments of the present disclosure, the heterogeneous inter-region graph convolution module may be used to determine an overall representation according to a plurality of intra-region representations.

Exemplarily, in such embodiments, a similarity between regions E_{c}={e_{g}, eᵥ, eₘ, eₚ} may be defined according to the geographical feature, the population visit feature, the mobility feature, and the resident population profile feature, where e_{g} represents a similarity of geographical features, eᵥ represents a similarity of population access features, eₘ represents a similarity of mobility features, and eₚ represents a similarity of permanent population profile features. The geographical feature is taken as an example below to describe a method of determining the similarity of geographical features. It may be understood that since the representation learning processes of the four features are similar, a method of determining the similarity of population visit features, a method of determining the similarity of mobility features and a method of determining the similarity of resident population profile features may refer to the method of determining the similarity of geographical features, which will not be described in detail here.

According to embodiments of the present disclosure, an edge constraint of the geographical feature may be defined for regions cⁱ and c^{j} as follows.

$${e}_{ij}^{g} = \{ \begin{matrix}1 , dis {t}_{g} ( {c}^{i} , {c}^{j} ) \leq {ε}_{g} \\ 0 , otherwise\end{matrix}$$

where dist_{g}(*) represents a Euclidean distance between geographical features.

An attention mechanism is introduced as follows.

βᵢⱼ=ν_{c}^{T} tanh(W_{c}[xₜ₊₁⁸⊕hᵤ^{j}⊕pᵢⱼ])

where ν_{c} and W_{c} are parameters that may be learned, and pᵢⱼ if represents a one-hot vector of four types of edges. Similarly, a weight αᵢⱼ of the heterogeneous inter-region graph convolution module may be calculated according to the weight calculation formula used by the event graph convolution module. Then the region-level representation may be calculated according to the following formula.

h_{c}^{i,l}=ReLU(W_{hc}^{l}(Σ_{j|N}_{ₜ}αᵢⱼh_{c}^{j,l-1}+I(l>1)h_{c}^{i,l-1}))

where h_{c}^{i,0}=hᵤⁱ. Then the overall feature may be derived as follows.

hₜ₊₁⁰=MLP([xₜ₊₁ⁱ⊕h_{e,t+1}^{L}^{ₑ}⊕h_{c}^{i,L}^{_{c}}])

According to embodiments of the present disclosure, the multi-task learning module may be used to perform a multi-task learning to determine price distribution data.

According to embodiments of the present disclosure, the learning tasks may be divided by areas to which the regions belong. Each area corresponds to a learning task. For example, if the regions are divided by communities, the learning tasks may be divided by urban districts or administrative areas to which the communities belong. These learning tasks share most of the parameters of the model, and generate price distribution data ŷₜ₊₁ in different regions through the fully connected output layer. The process may be expressed as the following formula.

ŷₜ₊₁=FCₘ(hₜ₊₁⁰)

where FCₘ represents a fully connected layer corresponding to an m^{th} learning task, and the m^{th} learning task corresponds to an m^{th} area; ŷₜ₊₁ represents an output result of the multi-task learning, that is, the price distribution data of the m^{th} area.

In the technical solutions of the present disclosure, a collection, a storage, a use, a processing, a transmission, a provision, a disclosure and an application of transaction events, feature data, model parameters and other data involved comply with provisions of relevant laws and regulations, take essential confidentiality measures, and do not violate public order and good custom. In the technical solution of the present disclosure, authorization or consent is obtained from the user before the user's personal information is obtained or collected.

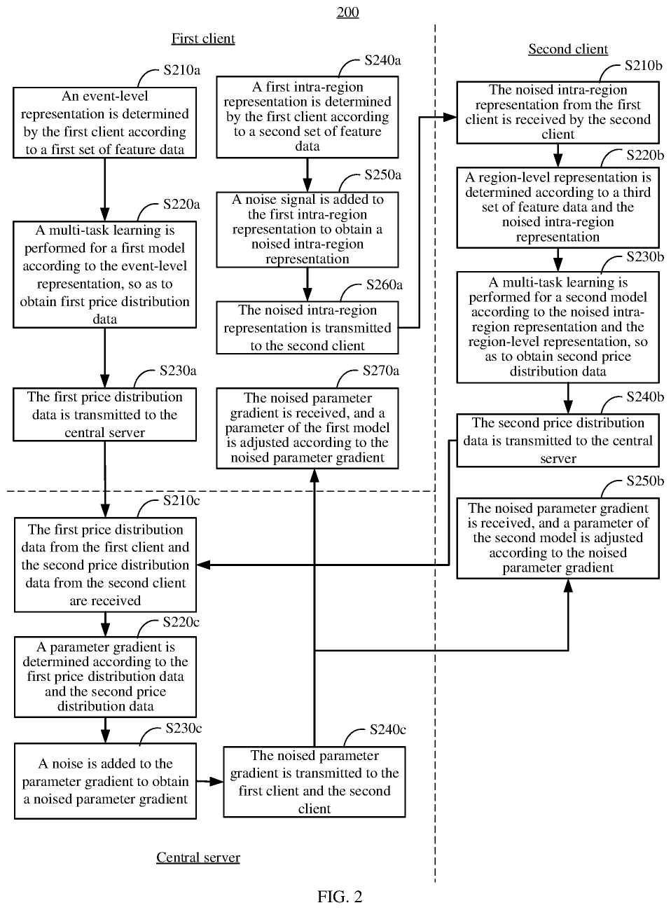

A method of training a model provided by the present disclosure will be described below with reference to FIG. 2.

FIG. 2 schematically shows a flowchart of a method of training a model according to embodiments of the present disclosure.

As shown in FIG. 2, a method 200 includes operations S210a to S270a, operations S210b to S250b, and operations S210c to S240c. Operations S210a to S270a may be performed, for example, by the first client shown above, operations S210b to S250b may be performed, for example, by the second client shown above, and operations S210c to S240c may be performed, for example, by the central server shown above.

In operation S210a, an event-level representation is determined by the first client according to a first set of feature data.

Then, in operation S220a, a multi-task learning is performed for a first model according to the event-level representation, so as to obtain first price distribution data.

In operation S230a, the first price distribution data is transmitted to the central server.

In addition, in operation S240a, a first intra-region representation is determined by the first client according to a second set of feature data.

In operation S250a, a noise signal is added to the first intra-region representation to obtain a noised intra-region representation.

In operation S260a, the noised intra-region representation is transmitted to the second client.

It should be noted that operations S210a to S230a may be performed firstly, and then operations S240a to S260a may be performed. It is also possible to perform operations S240a to S260a first, and then perform operations S210a to S230a. Operations S210a to S230a and operations S240a to S260a may also be performed simultaneously. The present disclosure does not specifically limit this.

Then, in operation S210b, the noised intra-region representation from the first client is received by the second client.

In operation S220b, a region-level representation is determined according to a third set of feature data and the noised intra-region representation.

In operation S230b, a multi-task learning is performed for a second model according to the noised intra-region representation and the region-level representation, so as to obtain second price distribution data.

In operation S240b, the second price distribution data is transmitted to the central server.

Next, in operation S210c, the first price distribution data from the first client and the second price distribution data from the second client are received by the central server.

In operation S220c, a parameter gradient is determined according to the first price distribution data and the second price distribution data.

In operation S230c, a noise is added to the parameter gradient to obtain a noised parameter gradient.

In operation S240c, the noised parameter gradient is transmitted to the first client and the second client.

In response to receiving the noised parameter gradient from the central server, the first client performs operation S270a to adjust a parameter of the first model according to the noised parameter gradient.

In response to receiving the noised parameter gradient from the central server, the second client performs operation S250b to adjust a parameter of the second model according to the noised parameter gradient.

According to embodiments of the present disclosure, the first model may be a model trained in the first client, and the first model may include, for example, the event graph convolution module and the dynamic intra-region graph convolution module shown above. The second model may be a model trained in the second client, and the second model may include, for example, the dynamic intra-region graph convolution module and the heterogeneous inter-region graph convolution module shown above.

According to embodiments of the present disclosure, the first set of feature data may be stored, for example, in the first client. The second set of feature data may be stored, for example, in the second client. Since the first client and the second client are isolated physically, the two clients may respectively save the feature data used for training, so that the possibility of exposure of feature data to each other may be reduced, and the security of private data may be improved.

According to embodiments of the present disclosure, the central server retrains the model parameters from the first client and the second client, and a training accuracy is higher. In addition, the differential privacy is added to the gradient when the central server transmits the gradient to each client, so that the possibility of privacy leakage may be reduced, and the security of data may be improved.

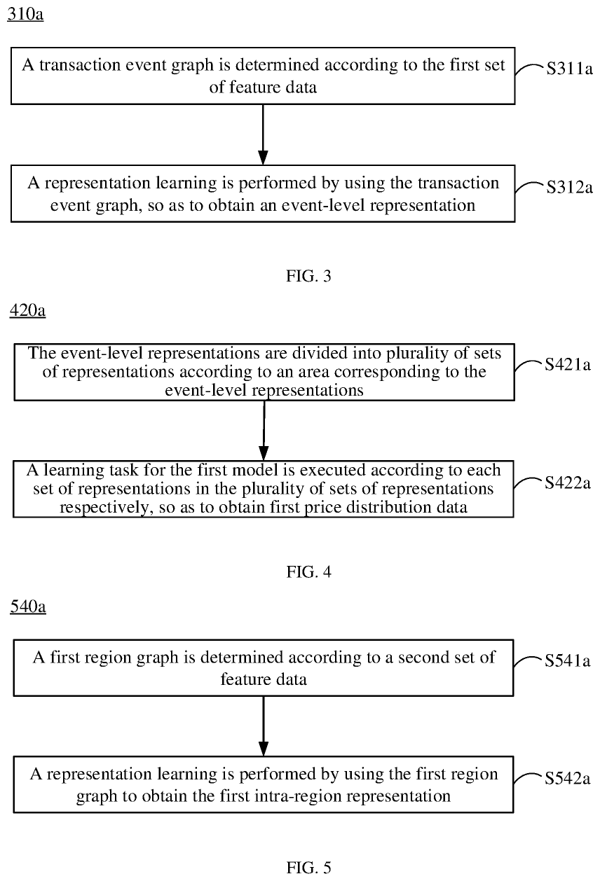

A method of determining an event-level representation according to embodiments of the present disclosure will be described below with reference to FIG. 3.

FIG. 3 schematically shows a flowchart of a method of determining an event-level representation according to embodiments of the present disclosure.

As shown in FIG. 3, a method 310a includes that, in operation S311a, a transaction event graph is determined according to the first set of feature data.

Then, in operation S312a, a representation learning is performed by using the transaction event graph, so as to obtain an event-level representation.

According to embodiments of the present disclosure, the first set of feature data may include, for example, asset profile features and temporal features of a plurality of transaction events.

According to embodiments of the present disclosure, for example, a first transaction event related to the prediction target in the plurality of transaction events may be determined according to the asset profile features and the temporal features of the plurality of transaction events. Then, the transaction event graph may be determined according to the asset profile feature and the temporal feature of the first transaction event.

For example, the prediction target may be the asset unit price at time t+1, and sₜ₊₁ represents the transaction event at time t+1. For each transaction event sₜ, in the first set of feature data, a physical distance between locations of two transaction events sₜ₊₁ and sₜ, and a time interval between occurrence times of the two transaction events may be determined. If the physical distance between two transaction events is less than or equal to a physical distance limit, and the time interval is less than or equal to a time interval limit, then it is determined that the transaction event sₜ, is the first transaction event related to the prediction target.

According to embodiments of the present disclosure, the method of determining the event-level representation may be performed, for example, by the event graph convolution module shown above.

A method of determining a first intra-region representation according to embodiments of the present disclosure will be described below with reference to FIG. 4.

FIG. 4 schematically shows a flowchart of a method of performing a multi-task learning on the first model according to embodiments of the present disclosure.

As shown in FIG. 4, a method 420a includes that, in operation S421a, the event-level representations are divided into plurality of sets of representations according to an area corresponding to the event-level representations.

Then, in operation S422a, a learning task for the first model is executed according to each set of representations in the plurality of sets of representations respectively, so as to obtain first price distribution data.

According to embodiments of the present disclosure, at least part of model parameters may be shared between the learning tasks corresponding to the plurality of sets of representations.

According to embodiments of the present disclosure, the event-level representations corresponding to a same area may be determined as a set of representations.

It may be understood that the distribution of asset transaction prices in different areas is not consistent. According to embodiments of the present disclosure, during the multi-task learning, price distributions in different areas may be learned through a fully connected layer, so as to obtain the first price distribution data.

According to embodiments of the present disclosure, the method of multi-task learning may be performed by, for example, the multi-task learning module shown above.

A method of determining a first intra-region representation according to embodiments of the present disclosure will be described below with reference to FIG. 5.

FIG. 5 schematically shows a flowchart of a method of determining a first intra-region representation according to embodiments of the present disclosure.

As shown in FIG. 5, a method 540a includes that, in operation S541a, a first region graph is determined according to a second set of feature data.

Then, in operation S542a, a representation learning is performed by using the first region graph to obtain the first intra-region representation.

According to embodiments of the present disclosure, the second set of feature data may include, for example, asset profile features, temporal features and regional features of a plurality of transaction events.

According to embodiments of the present disclosure, for example, the plurality of transaction events may be divided into a plurality of sets of transaction events according to the regional features of the plurality of transaction events. For each set of transaction events in the plurality of sets of transaction events, a second transaction event related to the prediction target in the set of transaction event may be determined. Then, a first region graph may be determined according to the asset profile feature, the temporal feature and the regional feature of each second transaction event. Each second transaction event may be used as a node in the first region graph. The asset profile feature, the temporal feature and the regional feature of the second transaction event may be used as features of the node.

For example, the regions may be divided by communities, and then the learning tasks may be divided by urban districts or administrative areas to which the communities belong. Transaction events in the same urban district or administrative area may be determined as a set of transaction events.

For example, the prediction target may be the asset unit price at time t+1, and s′ₜ₊₁1 represents the transaction event at time t+1. For each transaction event s′_{t′} in each set of transaction events, a physical distance between locations of two transaction events s′ₜ₊₁ and s′_{t′} and a time interval between occurrence times of the two transaction events may be determined. If the physical distance between the two transaction events is less than or equal to the physical distance limit, and the time interval is less than or equal to the time interval limit, then it is determined that the transaction event s′_{t′} is the second transaction event related to the prediction target.

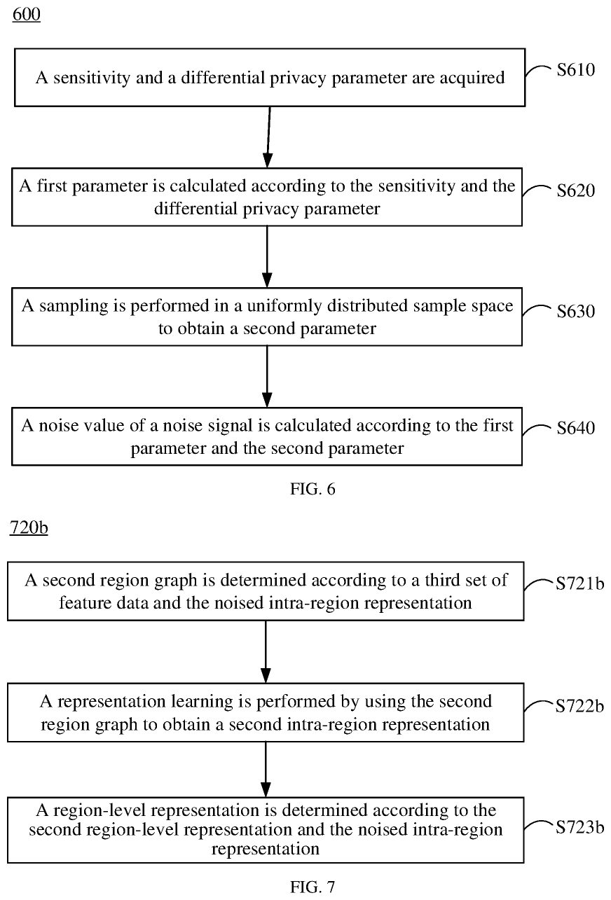

A method of calculating a noise value of a noise signal according to embodiments of the present disclosure will be described below with reference to FIG. 6.

FIG. 6 schematically shows a flowchart of a method of calculating a noise value of a noise signal according to embodiments of the present disclosure.

As shown in FIG. 6, a method 600 includes that, in operation S610, a sensitivity and a differential privacy parameter are acquired.

In operation S620, a first parameter is calculated according to the sensitivity and the differential privacy parameter.

In operation S630, a sampling is performed in a uniformly distributed sample space to obtain a second parameter.

In operation S640, a noise value of a noise signal is calculated according to the first parameter and the second parameter.

According to embodiments of the present disclosure, by adding a noise signal to the first intra-region representation, the possibility of privacy leakage may be reduced and the security of data may be improved.

According to embodiments of the present disclosure, the noise signal may include, for example, Laplace noise. In order to introduce the Laplace noise, a Laplace distribution is firstly explained below.

In such embodiments, the Laplace distribution is defined as follows.

$$L ( μ , b ) = f ( x \vert μ , b ) = \frac{1}{2 b} exp ( - \frac{\vert x - μ \vert}{b} ) = \frac{1}{2 b} \{ \begin{matrix}exp ( - \frac{μ - x}{b} ) , x < μ \\ exp ( - \frac{x - μ}{b} ) , x \geq μ\end{matrix}$$

where μ is a position parameter, and b>0 is a scale parameter.

An effect of protecting data privacy may be achieved by probabilizing an original single query result. In such embodiment, a probabilization of query result may be achieved based on the Laplace distribution. In order to measure an impact of the addition of noise on a real situation, a concept of sensitivity may be introduced.

For any query f:N^{|X|}→R^{k}, the sensitivity may be expressed as

$$Δ f = {max}_{x , y ∈ {N}^{\vert X \vert} , {‖ x - y ‖}_{1} = 1} {‖ f ( x ) - f ( y ) ‖}_{1} ,$$

where N^{|x|} represents a full set of data. The query f represents a numeric query that maps the full set of data N^{|x|} to a set of k-dimensional real numbers R^{k}.

The sensitivity may represent an impact of a loss/change/addition of a record in the dataset on a result of the query f. The larger the Δf, the greater the noise, and the smaller the Δf, the smaller the noise. Thus a Laplace mechanism is as follows.

Given a query f:N^{|X|}→R^{k}, the Laplace mechanism may be expressed as M_{L}(x, f(·),ϵ)=f(x)+(Y₁, Y₂, . . . , Yₖ), where Yᵢ is an independent and identically distributed variable, that is, Laplace random noise; ϵ represents a privacy budget (the smaller the privacy budget, the better the privacy protection, but the greater the noise), which may be set according to actual needs. Exemplarily, in such embodiments, an intermediate value of 1 may be selected for ϵ, a value less than 1 may be selected for more sensitive data, and a value greater than 1 may be selected for less sensitive data.

It may be proved that ϵ-differential privacy is met in a case of a noise

$$Y ∼ L ( 0 , \frac{Δ f}{ε} ) .$$

Based on this, according to embodiments of the present disclosure, the privacy budget ϵ may be selected as 1. A record in the input data may be cleared to 0, an output y′ may be calculated according to the changed input data, and an output without changing the input data may be recorded as y. A maximum value of 1-norm of y-y′ may be calculated. A value greater than the maximum value may then be determined as the sensitivity.

Then, the first parameter may be calculated according to the following formula.

$$b = \frac{Δ f}{ε}$$

where b represents the first parameter, Δf represents the sensitivity, and ϵ represents the differential privacy parameter.

Next, the second parameter may be obtained by sampling from a uniformly distributed sample space. The sample space may be determined according to actual needs. For example, a uniform distribution α˜UNI (˜0.5,0.5) may be determined. Then, the first parameter and the second parameter may be substituted into an inverse function of a Laplace distribution function, so as to obtain a noise value that meets the condition. This process may be expressed as the following calculation formula.

f⁻¹=−b·sign(α)·ln(1−2·|α|)

where f⁻¹ represents the noise value, b represents the first parameter, and α represents the second parameter.

A method of determining a region-level representation according to embodiments of the present disclosure will be described below with reference to FIG. 7.

FIG. 7 schematically shows a flowchart of a method of determining a region-level representation according to embodiments of the present disclosure.

As shown in FIG. 7, a method 720b includes that, in operation S721b, a second region graph is determined according to a third set of feature data and the noised intra-region representation.

In operation S722b, a representation learning is performed by using the second region graph to obtain a second intra-region representation.

In operation S723b, a region-level representation is determined according to the second region-level representation and the noised intra-region representation.

According to embodiments of the present disclosure, the third set of feature data may include, for example: additional features of a plurality of regions. The additional feature includes at least one selected from: a geographical feature, a population visit feature, a mobility features, and a resident population profile feature.

According to embodiments of the present disclosure, for example, a transaction event corresponding to the third set of feature data and each feature data in each noised intra-region representation may be determined as a node in the second region graph. The asset profile feature, the temporal feature and the regional feature of the transaction event may be determined as the features of the node.

According to embodiments of the present disclosure, for example, the third set of feature data and the noised intra-region representation may be divided into a plurality of sets of regional features according to the regions corresponding to the third set of feature data and the noised intra-region representation. For each set of regional features in the plurality of sets of regional features, a target feature related to the prediction target may be determined from the set of regional features. Then the second region graph may be determined according to the target feature.

According to embodiments of the present disclosure, for example, a region-level representation may be determined by the heterogeneous inter-community graph convolution module shown above.

A method of performing a multi-task learning for a second model according to embodiments of the present disclosure will be described below with reference to FIG. 8.

FIG. 8 schematically shows a flowchart of the method of performing the multi-task learning for the second model according to embodiments of the present disclosure.

As shown in FIG. 8, a method 830b includes that, in operation S831b, the noised intra-region representation and the region-level representation are divided into a plurality of sets of representations according to the regions corresponding to the noised intra-region representation and the region-level representation.

In operation S832b, a learning task for the second model is performed for each set of representations in the plurality of sets of representations respectively, so as to obtain second price distribution data.

At least part of the model parameters are shared between the learning tasks corresponding to the plurality of sets of representations.

According to embodiments of the present disclosure, regions may belong to different areas. In such embodiments, if the regions corresponding to the noised intra-region representation and the region-level representation belong to a same area, these features may be divided into one set of representations.

According to embodiments of the present disclosure, the central server stores transaction unit prices of all transaction events used by the first client and the second client. The central server may calculate a gradient of each transaction unit price in a batch and clip them to a fixed maximum norm. The maximum norm may be used to limit a length or a size of a vector, and the maximum norm may be determined according to actual needs. They are then aggregated into a single parameter gradient. Gaussian noise is then added to each parameter gradient.

Exemplarily, Facebook's open-source differential privacy library Opacus may be used for the differential privacy for gradient.

According to embodiments of the present disclosure, for example, the learning task for the second model may be executed by the multi-task learning module shown above.

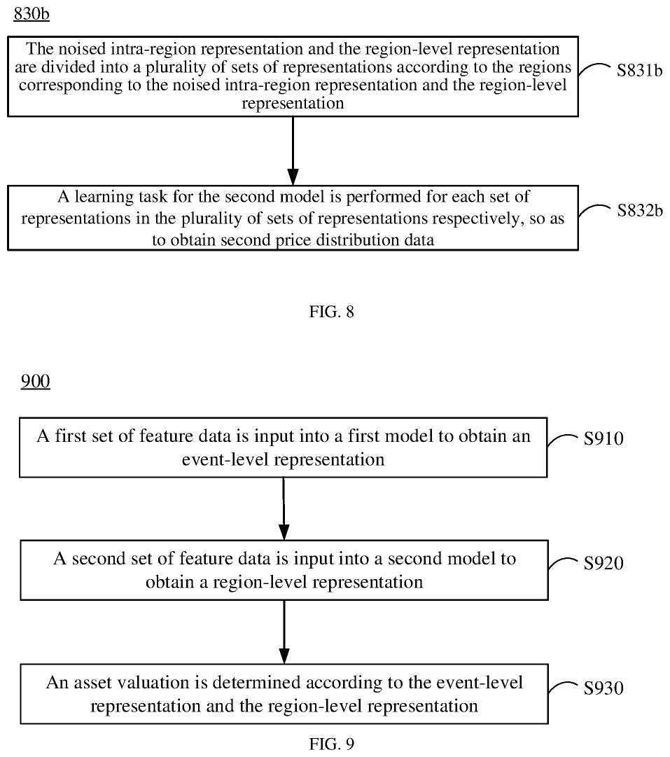

A method of determining an asset valuation provided by the present disclosure will be described below with reference to FIG. 9.

FIG. 9 schematically shows a flowchart of the method of determining the asset valuation according to embodiments of the present disclosure.

As shown in FIG. 9, a method 900 includes that, in operation S910, a first set of feature data is input into a first model to obtain an event-level representation.

In operation S920, a second set of feature data is input into a second model to obtain a region-level representation.

In operation S930, an asset valuation is determined according to the event-level representation and the region-level representation.

According to embodiments of the present disclosure, the first set of feature data may include, for example, an asset profile feature and a temporal feature. The second set of feature data may include, for example, an asset profile feature, a regional feature, a temporal feature, and an additional feature. The additional feature may include at least one selected from a geographical feature, a population visit feature, a mobility feature, or a resident population profile feature.

According to embodiments of the present disclosure, the first model may include, for example, the event graph convolution module and the dynamic intra-region graph convolution module shown above. The second model may be a model trained in the second client, and the second model may include, for example, the dynamic intra-region graph convolution module and the heterogeneous inter-region graph convolution module shown above. For the methods of training the first model and the second model, for example, reference may be made to the above, which will not be repeated here.

According to embodiments of the present disclosure, for example, the event-level representation and the region-level representation may be input into a fully connected layer to obtain the asset valuation. The fully connected layer may be trained, for example, by the central server shown above. In such embodiments, the asset may include, for example, real estate, and the asset valuation may include, for example, a unit price of a real estate transaction.

The method of determining the asset valuation according to embodiments of the present disclosure may be used to predict a future asset valuation according to historical transaction data, and the prediction has a high accuracy.

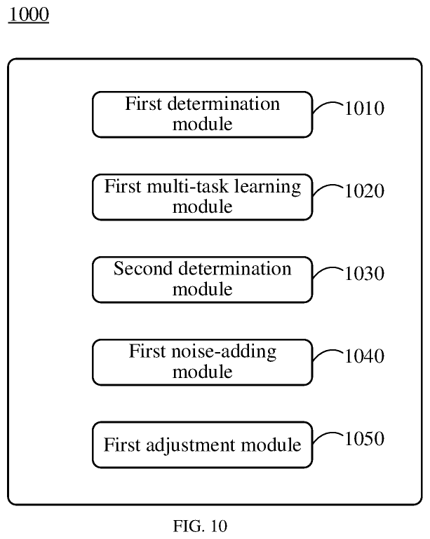

FIG. 10 schematically shows a block diagram of an apparatus of training a model according to embodiments of the present disclosure.

As shown in FIG. 10, an apparatus 1000 of training a model includes a first determination module 1010, a first multi-task learning module 1020, a second determination module 1030, a first noise-adding module 1040, and a first adjustment module 1050.

The first determination module 1010 may be used to determine an event-level representation according to a first set of feature data.

The first multi-task learning module 1020 may be used to perform a multi-task learning for a first model according to the event-level representation, so as to obtain first price distribution data, and transmit the first price distribution data to a central server.

The second determination module 1030 may be used to determine a first intra-region representation according to a second set of feature data.

The first noise-adding module 1040 may be used to add a noise signal to the first intra-region representation to obtain a noised intra-region representation, and transmit the noised intra-region representation to a client.

The first adjustment module 1050 may be used to adjust a parameter of the first model according to a noised parameter gradient in response to the noised parameter gradient being received from the central server.

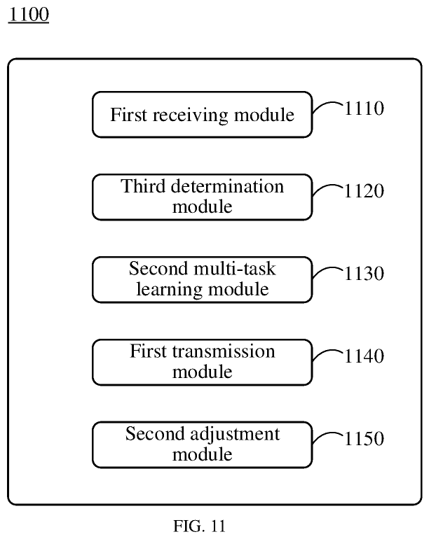

FIG. 11 schematically shows a block diagram of an apparatus of training a model according to other embodiments of the present disclosure.

As shown in FIG. 11, an apparatus 1100 of training a model incudes a first receiving module 1110, a third determination module 1120, a second multi-task learning module 1130, a first transmission module 1140, and a second adjustment module 1150.

The first receiving module 1110 may be used to receive a noised intra-region representation from a client.

The third determination module 1120 may be used to determine a region-level representation according to a third set of feature data and the noised intra-region representation.

The second multi-task learning module 1130 may be used to perform a multi-task learning for a second model according to the noised intra-region representation and the region-level representation, so as to obtain second price distribution data.

The first transmission module 1140 may be used to transmit the second price distribution data to a central server.

The second adjustment module 1150 may be used to adjust a parameter of the second model according to a noised parameter gradient in response to the noised parameter gradient being received from the central server.

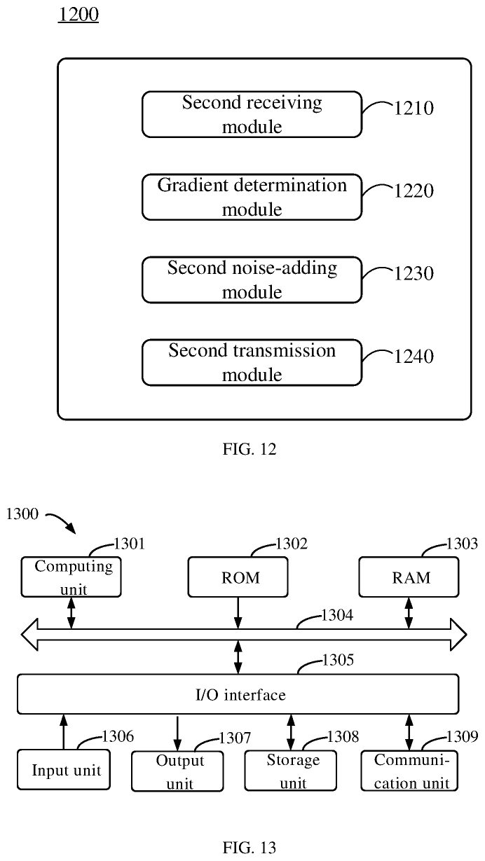

FIG. 12 schematically shows a block diagram of an apparatus of training a model according to embodiments of the present disclosure.

As shown in FIG. 12, an apparatus 1200 of training a model includes a second receiving module 1210, a gradient determination module 1220, a second noise-adding module 1230, and a second transmission module 1240.

The second receiving module may be used to receive first price distribution data from a first client and second price distribution data from a second client.

The gradient determination module 1220 may be used to determine a parameter gradient according to the first price distribution data and the second price distribution data.

The second noise-adding module 1230 may be used to add a noise to the parameter gradient to obtain a noised parameter gradient.

The second transmission module 1240 may be used to transmit the noised parameter gradient to the first client and the second client.

According to embodiments of the present disclosure, the present disclosure further provides an electronic device, a readable storage medium, and a computer program product.

FIG. 13 schematically shows a block diagram of an example electronic device 1300 suitable for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 13, the electronic device 1300 includes a computing unit 1301 which may perform various appropriate actions and processes according to a computer program stored in a read only memory (ROM) 1302 or a computer program loaded from a storage unit 1308 into a random access memory (RAM) 1303. In the RAM 1303, various programs and data necessary for an operation of the electronic device 1300 may also be stored. The computing unit 1301, the ROM 1302 and the RAM 1303 are connected to each other through a bus 1304. An input/output (I/O) interface 1305 is also connected to the bus 1304.

A plurality of components in the electronic device 1300 are connected to the I/O interface 1305, including: an input unit 1306, such as a keyboard, or a mouse; an output unit 1307, such as displays or speakers of various types; a storage unit 1308, such as a disk, or an optical disc; and a communication unit 1309, such as a network card, a modem, or a wireless communication transceiver. The communication unit 1309 allows the electronic device 1300 to exchange information/data with other devices through a computer network such as Internet and/or various telecommunication networks.

The computing unit 1301 may be various general-purpose and/or dedicated processing assemblies having processing and computing capabilities. Some examples of the computing units 1301 include, but are not limited to, a central processing unit (CPU), a graphics processing unit (GPU), various dedicated artificial intelligence (Al) computing chips, various computing units that run machine learning model algorithms, a digital signal processing processor (DSP), and any suitable processor, controller, microcontroller, etc. The computing unit 1301 executes various methods and steps described above, such as the method of training the model and the method of determining the asset valuation. For example, in some embodiments, the method of training the model and the method of determining the asset valuation may be implemented as a computer software program which is tangibly embodied in a machine-readable medium, such as the storage unit 1308. In some embodiments, the computer program may be partially or entirely loaded and/or installed in the electronic device 1300 via the ROM 1302 and/or the communication unit 1309. The computer program, when loaded in the RAM 1303 and executed by the computing unit 1301, may execute one or more steps in the method of training the model and the method of determining the asset valuation described above. Alternatively, in other embodiments, the computing unit 1301 may be configured to perform the method of training the model and the method of determining the asset valuation by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of training a model, the method comprising:
determining an event-level representation according to a first set of feature data;
performing a multi-task learning for a first model according to the event-level representation, so as to obtain first price distribution data, and transmitting the first price distribution data to a central server;
determining a first intra-region representation according to a second set of feature data;
adding a noise signal to the first intra-region representation to obtain a noised intra-region representation, and transmitting the noised intra-region representation to a client; and
adjusting a parameter of the first model according to a noised parameter gradient in response to the noised parameter gradient being received from the central server.

2. The method according to claim 1, further comprising:
acquiring a sensitivity and a differential privacy parameter;
calculating a first parameter according to the sensitivity and the differential privacy parameter;
sampling from a uniformly distributed sample space to obtain a second parameter; and
calculating a noise value of the noise signal according to the first parameter and the second parameter.

3. The method according to claim 2, wherein the calculating a first parameter according to the sensitivity and the differential privacy parameter comprises:
calculating the first parameter according to:
$$b = \frac{Δ f}{ε}$$
where b represents the first parameter, Δf represents the sensitivity, and ϵ represents the differential privacy parameter.

4. The method according to claim 2, wherein the calculating a noise value of the noise signal according to the first parameter and the second parameter comprises:
calculating the noise value according to:
f⁻¹=−b·sign(α)·ln(1−2√|α|)
where f⁻¹ represents the noise value, b represents the first parameter, and α represents the second parameter.

5. The method according to claim 1, wherein the determining an event-level representation according to a first set of feature data comprises:
determining a transaction event graph according to the first set of feature data; and
performing a representation learning by using the transaction event graph, so as to obtain the event-level representation.

6. The method according to claim 5, wherein the first set of feature data comprises:
asset profile features and temporal features of a plurality of transaction events; and
wherein the determining a transaction event graph according to the first set of feature data comprises:
determining a first transaction event related to a prediction target from the plurality of transaction events according to the asset profile features and the temporal features of the plurality of transaction events; and
determining the transaction event graph according to the asset profile feature and the temporal feature of the first transaction event.

7. The method according to claim 1, wherein the determining a first intra-region representation according to a second set of feature data comprises:
determining a first region graph according to the second set of feature data; and
performing a representation learning by using the first region graph, so as to obtain the first intra-region representation.

8. The method according to claim 7, wherein the second set of feature data comprises: asset profile features, temporal features and regional features of a plurality of transaction events; and
wherein the determining a first region graph according to the second set of feature data comprises:
dividing the plurality of transaction events into a plurality of sets of transaction events according to the regional features of the plurality of transaction events;
for each set of transaction events in the plurality of sets of transaction events,
determining a second transaction event related to a prediction target from the set of transaction events; and
determining the first region graph according to the asset profile feature, the temporal feature and the regional feature of the second transaction event,
wherein the performing a multi-task learning for a first model according to the event-level representation, so as to obtain first price distribution data comprises:
dividing the event-level representation into a plurality of sets of representations according to an area corresponding to the event-level representation; and
executing a learning task for the first model according to each set of representations in the plurality of sets of representations respectively, so as to obtain the first price distribution data, wherein at least part of model parameters is shared between the learning tasks corresponding to the plurality of sets of representations.

9. A method of training a model, the method comprising:
receiving a noised intra-region representation from a client;
determining a region-level representation according to a third set of feature data and the noised intra-region representation;
performing a multi-task learning for a second model according to the noised intra-region representation and the region-level representation, so as to obtain second price distribution data;
transmitting the second price distribution data to a central server; and
adjusting a parameter of the second model according to a noised parameter gradient in response to the noised parameter gradient being received from the central server.

10. The method according to claim 9, wherein the determining a region-level representation according to a third set of feature data and the noised intra-region representation comprises:
determining a second region graph according to the third set of feature data and the noised intra-region representation,
performing a representation learning by using the second region graph, so as to obtain a second intra-region representation, and
determining the region-level representation according to the second intra-region representation and the noised intra-region representation; and
wherein the determining a second region graph according to the third set of feature data and the noised intra-region representation comprises:
dividing the third set of feature data and the noised intra-region representation into a plurality of sets of regional features according to a region corresponding to the third set of feature data and the noised intra-region representation,
for each set of regional features in the plurality of sets of regional features,
determining a target feature related to a prediction target from the set of regional features; and
determining the second region graph according to the target feature; and
wherein the performing a multi-task learning for a second model according to the noised intra-region representation and the region-level representation, so as to obtain second price distribution data comprises:
dividing the noised intra-region representation and the region-level representation into a plurality of sets of representations according to a region corresponding to the noised intra-region representation and the region-level representation, and
executing, for each set of representations in the plurality of sets of representations, a learning task for the second model to obtain the second price distribution data, wherein at least part of model parameters is shared between the learning tasks corresponding to the plurality of sets of representations,
wherein the third set of feature data comprises additional features of a plurality of regions, wherein the additional feature comprises at least one selected from: a geographical feature, a population visit feature, a mobility feature, or a resident population profile feature.

11. A method of training a model, the method comprising:
receiving first price distribution data from a first client and second price distribution data from a second client;
determining a parameter gradient according to the first price distribution data and the second price distribution data;
adding a noise to the parameter gradient to obtain a noised parameter gradient; and
transmitting the noised parameter gradient to the first client and the second client.

12. A method of determining an asset valuation, the method comprising:
inputting a first set of feature data into a first model to obtain an event-level representation;
inputting a second set of feature data into a second model to obtain a region-level representation; and
determining the asset valuation according to the event-level representation and the region-level representation,
wherein the first model is trained according to the method of claim 1,
wherein the first set of feature data comprises an asset profile feature and a temporal feature,
wherein the second set of feature data comprises an asset profile feature, a regional feature, a temporal feature and an additional feature, and
wherein the additional feature comprises at least one selected from: a geographical feature, a population visit feature, a mobility feature, or a resident population profile feature.

13. An electronic device, comprising:
at least one processor; and
a memory communicatively connected to the at least one processor, wherein the memory stores instructions executable by the at least one processor, the instructions, when executed by the at least one processor, configured to cause the at least one processor to implement at least the method of claim 1.

14. An electronic device, comprising:
at least one processor; and
a memory communicatively connected to the at least one processor, wherein the memory stores instructions executable by the at least one processor, the instructions, when executed by the at least one processor, configured to cause the at least one processor to implement at least the method of claim 9.

15. An electronic device, comprising:
at least one processor; and
a memory communicatively connected to the at least one processor, wherein the memory stores instructions executable by the at least one processor, the instructions, when executed by the at least one processor, configured to cause the at least one processor to implement at least the method of claim 11.

16. An electronic device, comprising:
at least one processor; and
a memory communicatively connected to the at least one processor, wherein the memory stores instructions executable by the at least one processor, the instructions, when executed by the at least one processor, configured to cause the at least one processor to implement at least the method of claim 12.

17. A non-transitory computer-readable storage medium having computer instructions therein, the computer instructions configured to cause a computer system to implement at least the method of claim 1.

18. A non-transitory computer-readable storage medium having computer instructions therein, the computer instructions configured to cause a computer system to implement at least the method of claim 9.

19. A non-transitory computer-readable storage medium having computer instructions therein, the computer instructions configured to cause a computer system to implement at least the method of claim 11.

20. A non-transitory computer-readable storage medium having computer instructions therein, the computer instructions configured to cause a computer system to implement at least the method of claim 12.
